(19) United States
(12) Patent Application Publication
(10) Pub. No.: US 2003/0204560 A1
(43) Pub. Date: Oct. 30, 2003

(54) Programmable Logic Controller with embedded Intelligent Web Server

(76) Inventors: Thomas C.H. Chen, Houston, TX (US); Jenny P. Chen, Houston, TX (US)

Correspondence Address: Thomas C. H. Chen, 5468 Cedar Creek Drive, Houston, TX, 77056, US

(21) Appl. No.: 10/133,030

(22) Filed: Apr. 26, 2002

(51) Int. Cl. G06F 15/16

(52) U.S. Cl. 709/203

(57) ABSTRACT

A System Apparatus of Programmable Logic Controller (PLC) 100 containing System Software of Embedded Intelligent Web Server 200 uses a service-based application method to administrate and manage of control and system related services for controlling machines, equipment and manufacturing processes globally. The main component of System Apparatus of Programmable Logic Controller 100 is Central Processing Unit 110 which is connected to an Apparatus Memory 120, a Wireline Connection Port 140, a Wireless Transceiver Port 150, a plurality of Input Interface Module 160, and a plurality of Output Interface Module 170. Input Interface Module 160 is connected to a plurality of Field Input Device 180, and Output Interface Module 170 is connected to a plurality of Field Output Device 190. System Apparatus of Programmable Logic Controller 100 is also connected by a Power Supply 130 for power source. System Software of Embedded Intelligent Web Server 200 resides in Central Processing Unit 100 and is comprised of a Real-time Operation System (RTOS) 210, a Runtime Language Executor 220, a Service Central Controller 230. Service Central Controller 230 is comprised of a Service Administrator 231, a Service Shared Memory 232, a plurality of Grouped and Prioritized Input Service 241, a plurality of Grouped and Prioritized Output Service 242, a plurality of Intelligent Agent Monitoring Service 243, a HTTP Service 251, a Wireline Data Service 252, a Wireless Data Service 253, and a Store and Forward Message Service 254. Service Central Controller 230 is responsible for registering, installing, activating, deactivating, and uninstalling all control and system related services of PLC operations dynamically at runtime. Each control or system service, although executed independently, can be called by other services for accomplishing complex or collaborating tasks.

### BACKGROUND—FIELD OF INVENTION

This invention relates in general to Programmable Logic Controller (PLC), and in particular to embedding an Intelligent Web Server in a PLC for concurrent execution of multiple control and system related services.

### BACKGROUND—DESCRIPTION OF PRIOR ART

Programmable Logic Controller (PLC) is well understood in the art. A PLC is an microcomputer-based controller that uses stored instructions in programmable memory to control machinery, equipment, and manufacturing processes. It can also be used to assist the CNC (Computer Numerical Control) system in controlling of complex NC (Numerical Control) machine tools and flexible manufacturing modules and cells. PLCs were originally developed as a substitute for electrical relays. PLCs, however, have many advantages over conventional relays in easier programming and reprogramming, increased compactness, more control functions, and better reliability.

Different programming methods for control functions can be used with PLCs. For example, in U.S. Pat. No. 6,141,628 to Workth et al., it describes a computer-implemented method for determining whether a physical input is analog or discrete and whether the input is in fault, so that proper response can be taken. In another example, the U.S. Pat. No. 5,978,593 to Sexton reveals a computer system including a host programmable logic controller coupled with a field bus to programmable bus interface for achieving flexibility in specifying the control needed among the host programmable logic control, the micro field processor and the I/O modules. Also, the U.S. Pat. No. 5,923,903 to Alvarez-Escurra et al. details a programmable logic controller input-output system that can be used to configure I/O couplers or interfaces independent of the logic controller topology. The PLC related programming described in above patents uses library-based application method in which each application has to be compiled and linked to software library in order to build a complete runtime module. Whenever there is a change in applications, the entire runtime module has to be re-compiled and re-linked. Since PLC control functions needed to be modified frequently due to device specification or operation procedure changes, a service-based application method is a more flexible and reliable programming approach for PLC control functions. In the service-based application method, multiple service units are plugged in side by side. Since each service unit is executed independently from each other, modifying and rebuilding a service will not effect other parts of the application. With proper configuration, one service can also be used by other services for task collaboration purpose. In the service-based application method, a service central controller is needed to administrate and manage all services under its control. The service central controller is also needed to support automatically discovering of any new services. The usage of service-based application method can extend PLC control functions beyond their traditional process of input and output signaling.

A typical operation cycle of PLC is called a scan, which consists of three steps: 1) input scan, 2) program scan, and 3) output scan. Each step of the scan is executed in a single thread sequence. Entire three steps will consume certain amount of CPU (Central Processing Unit) time, sometimes referred to as scan time. The length of scan time can vary depending on the number of inputs needed to be scanned, the complexity of control functions needed to be processed, and the number of outputs needed to be changed. There are two drawbacks of executing scan cycle in a single thread sequence. The first drawback relates to the changes of a particular output that is needed by another input. Since program scan uses the output of the previous scan step for the input of the current scan step, there is a potential risk if an output is changed during the current scan cycle. The second drawback relates to the performance of CPU. The processing speed of CPU are typically doubling every 18 months. Executing scan in a single thread sequence will result a large amount of unused CPU power, since there is an I/O limitation of how fast input signals can be read in and how fast output signals can be sent out. In the service-based application method described above, all services are running under a multi-thread system environment. By grouping and prioritizing inputs and outputs in separate groups, and treating each input or output group as a separate service, the CPU power can be utilized to a full extent.

The basic PLC operations include logic control for event-driven changes and sequencing control for time-driven changes in a system. The results of logic control or sequence control will cause output values to be on or off, and hence can be used for machine control or process control. As the functions of PLC become more complicated and diversified, intelligent capabilities can be built into PLC to handle more complex tasks than simple input and output scanning. Example of these capabilities include faulty detection, emergency shutdown, machine wear out warning, alarm triggering, and status reporting. Intelligent agent based service is a good approach to implement these capabilities for PLC. Intelligent agent based service has two basic characteristics, 1) acting on the behalf of its owner, and 2) acting autonomously when needed. By putting all real-time information of input and output services into PLC's shared memory and allowing other services to access it concurrently, various intelligent agent based services can be deployed for monitoring, controlling, status reporting, alarm trigging, or message delivering tasks.

The popularity of Internet has expanded rapidly in recent years. Many inventions have applied Internet and related technologies to PLC. For example, the U.S. Pat. No. 6,151,625 to Swales et al., and U.S. Pat. No. 6,282,454 to Papadopoulos et al. describe a control system including an HTTP (HyperText Transfer Protocol) Web interface to a network that consists of at least one programmable logic control system, which allows users to retrieve all pertinent data regarding the operation of the PLC system. In another example of the U.S. Pat. No. 6,263,487 to Stripf et al., it reveals a programmable controller suitable for use in a globally distributed automation network. All the patents above, however, use HTTP Web server as an interface to PLC for either data access or I/O control. HTTP Web server used in this case is acting as middleware, not directly embedded into the CPU of PLC. The main advantage of embedded-based HTTP Web server over middleware-based HTTP Web server is that it can be accessed globally without the presence of other software which may experience traffic jams or process bottlenecks. The other advantage of embedded-based HTTP Web server is that it has better mobility and flexibility in terms of hardware and software installation, since no network connection to a separate Internet Web server is needed.

Wireline and wireless data communications has become cheaper and faster in recent days. Wireline data communication uses landline network such as Ethernet, to transmit data through TCP/IP (Transmission Control Protocol/Internet Protocol), or TCP/UDP (Transmission Control Protocol/User Datagram Protocol) protocols. Wireless data communication uses either a wide-area cellular network, such as CDPD (Cellular Digital Packet Data), GSM (Global System for Mobile), GPRS (General Packet Radio System), and W-CDMA (Wideband Code Division Multiple Access), or a short-range local wireless network, such as Bluetooth, and HomeRF. Many wireless communication protocols, such as WDP (Wireless Datagram Protocol), WTP (Wireless Transaction Protocol), WSP (Wireless Session Protocol), RFCOM (RF COM Port) can be used in conjunction with wireless network. By including both wireline and wireless data communication capabilities in an embedded HTTP Web server, it allows a PLC to be accessible and controllable globally through regular computer, cellular phone, or portable devices.

Although Internet and wireless connection is economic and easy to install and use, it is not as reliable as dedicated network connection. Internet and wireless communication traffic are fluctuating at all times depending on how many users are actually online. Hence, the connection may not be available or persistent when access is needed. A store and forward message service is a capability that can automatically detect the availability of wireline or wireless communication connection, store the message when the connection is not accessible, and delivery the message to the destination when the connection resumed. By incorporating store and forward message service in an embedded HTTP Web server, it guarantees the delivery of PLC's message to the outside world, even if the connection is temporally down.

A need exists for a Programmable Logic Controller (PLC) containing an embedded intelligent Web server which includes a service central controller that uses a service-based application method for PLC operations. A need also exists for a PLC containing an embedded intelligent Web server which can provide control related services, such as grouped and prioritized input service, grouped and prioritized output service, and intelligent agent monitoring service. A need also exists for a PLC containing an embedded intelligent Web server which can provide system related services, such as HTTP service, wireline data service, wireless data service, and store and forward message service.

### OBJECTS AND ADVANTAGES

It is therefore an object of the invention to provide a Programmable Logic Controller (PLC) containing an Embedded Intelligent Web Server which includes a Service Central Controller that uses a service-based application method to administrate and manage the control and system related services for PLC operations. The Service Central Controller is responsible for registering, installing, activating, deactivating, and uninstalling all services dynamically. The Service Central Controller also tracks dependencies among services and sends event notifications when needed. In addition, the Service Central Controller automatically checks registration of any new services that are deployed at runtime.

Another object of the invention is to provide a plurality of Grouped and Prioritized Input Service that are administrated and managed by the Service Central Controller for PLC input functions. The Grouped and Prioritized Input Service is a control related PLC service. All input signals for the PLC can be categorized into different groups for separate scanning purposes. Different priorities can be set for different inputs within the group. During each input scanning cycle, a higher priority input is scanned first. All services of the input group are deployed separately, and run concurrently under separate system threads.

Another object of the invention is to provide a plurality of Grouped and Prioritized Output Service that are administrated and managed by the Service Central Controller for PLC output functions. The Grouped and Prioritized Output Service is a control related PLC service. All output signals of the PLC can also be divided into separate groups with different priority settings. The output values with a higher priority in the group is changed first during each output scanning cycle.

Another object of the invention is to provide a plurality of Intelligent Agent Monitoring Service that are administrated and managed by the Service Central Controller for PLC monitoring and controlling tasks. The Intelligent Agent Monitoring Service is also a control related PLC service. Each Intelligent Agent Monitoring Service consists of a generic rule engine and a set of service rules. Generic rule engine is used to process service rules at runtime. Multiple Intelligent Agent Monitoring Service can be deployed and communicated with each other through the service shared memory.

Another object of the invention is to provide a Wireline Data Service that is administrated and managed by the Service Central Controller for PLC wireline communication connectivity. The Wireline Data Service is a system related PLC service. The Wireline Data

Service includes a TCP/IP stack, a TCPIUDP stack, and contains device drivers for necessary wireline network connection.

Another object of the invention is to provide a Wireless Data Service that is administrated and managed by the Service Central Controller for PLC wireless communication connectivity. The Wireless Data Service is a system related PLC service. It contains different wireless communication protocols such as WAP (Wireless Application Protocol) for cellular network, and SDP (Service Discovery Protocol) for Bluetooth short-range RF network. The Wireless Data Service also contains necessary wireless device drivers to link with wireless transceiver and antenna.

Another object of the invention is to provide a HTTP (HyperText Transfer Protocol) Service that is administrated and managed by the Service Central Controller for PLC Internet accessibility. The HTTP Service is a system related PLC service. It contains a thin HTTP Web server for direct Internet access. The HTTP Service uses Wireline Data Service and/or Wireless Data Service as underlying network transporter.

It is an additional object of the invention to provide a Store and Forward Message Service that is administrated and managed by the Service Central Controller for the delivery of PLC message. The Store and Forward Message Service is also a system related PLC service. It uses Wireline Data Service and/or Wireless Data Service as communication medium for asynchronous delivery of messages. The Store and Forward Message Service can detect the availability of wireline or wireless communication network and determine a preferred data service method to transmit the messages.

Further objects and advantages of this invention will become apparent from a consideration of the ensuing description and accompanying drawings.

### BRIEF DESCRIPTION OF THE DRAWINGS

For a further understanding of the objects and advantages of the present invention, reference should be made to the following drawings in conjunction with the accompanying descriptions, wherein:

FIG. 1 is an illustrative block diagram of the System Apparatus of Programmable Logic Controller of this invention;

FIG. 2. is an illustrative block diagram of the System Software of Embedded Intelligent Web Server of this invention;

FIG. 3 is a flow chart illustrating the administration and management flow of Service Central Controller;

FIG. 4 is a flow chart illustrating the control service flow of Grouped and Prioritized Input Service;

FIG. 5 is a flow chart illustrating the control service flow of Grouped and Prioritized Service;

FIG. 6 is a flow chart illustrating the control service flow of Intelligent Agent Monitoring Service;

FIG. 7 is a flow chart illustrating the system service flow of HTTP Service;

FIG. 8 is a flow chart illustrating the system service flow of Wireline Data Service;

FIG. 9 is a flow chart illustrating the system service flow of Wireless Data Service;

FIG. 10 is a flow chart illustrating the system service flow of Store and Forward Message Service.

### REFERENCE NUMERALS

| | | | |
|---|---|---|---|
| 100 | System Apparatus of | 110 | Central Processing Unit |
| | Programmable Logic | | (CPU) |
| | Controller (PLC) | | |
| 120 | Apparatus Memory | 130 | Power Supply |
| 140 | Wireline Connection Port | 150 | Wireless Transceiver |
| | | | Port |
| 160 | Input Interface Module | 170 | Output Interface Module |
| 180 | Field Input Device | 190 | Field Output Device |
| 200 | System Software of Embedded | 210 | Real-time Operating |
| | Intelligent Web Server | | System (RTOS) |
| 220 | Runtime Language Executor | 230 | Service Central |
| | | | Controller |
| 231 | Service Administrator | 232 | Service Shared Memory |
| 241 | Grouped and Prioritized | 242 | Grouped and Prioritized |
| | Input Service | | Output Service |
| 242 | Intelligent Agent | 251 | HTTP Service |
| | Monitoring Service | | |
| 252 | Wireline Data Service | 253 | Wireless Data Service |
| 254 | Store and Forward | | |
| | Message Service | | |

### SUMMARY

A System Apparatus of Programmable Logic Controller (PLC) containing System Software of Embedded Intelligent Web Server uses a service-based application method to administrate and manage control and system related services for controlling machines, equipment and manufacturing processes globally. The main component of System Apparatus of Programmable Logic Controller is Central Processing Unit which is connected to an Apparatus Memory, a Wireline Connection Port, a Wireless Transceiver Port, a plurality of Input Interface Module, and a plurality of Output Interface Module. Input Interface Module is connected to a plurality of Field Input Device, and Output Interface Module is connected to a plurality of Field Output Device. System Apparatus of Programmable Logic Controller is also connected by a Power Supply for power source. System Software of Embedded Intelligent Web Server resides in Central Processing Unit and is comprised of a Real-time Operation System (RTOS), a Runtime Language Executor, and a Service Central Controller. Service Central Controller is comprised of a Service Administrator, a Service Shared Memory, a plurality of Grouped and Prioritized Input Service, a plurality of Grouped and Prioritized Output Service, a plurality of Intelligent Agent Monitoring Service, a HTTP Service, a Wireline Data Service, a Wireless Data Service, and a Store and Forward Message Service. Service Administrator of Service Central Controller is responsible for registering, installing, activating, deactivating, and uninstalling all control and system related services of PLC operations dynamically at runtime. Each control or system service, although executed independently, can be called by other services for accomplishing complex or collaborating tasks.

Preferred Embodiment—Description

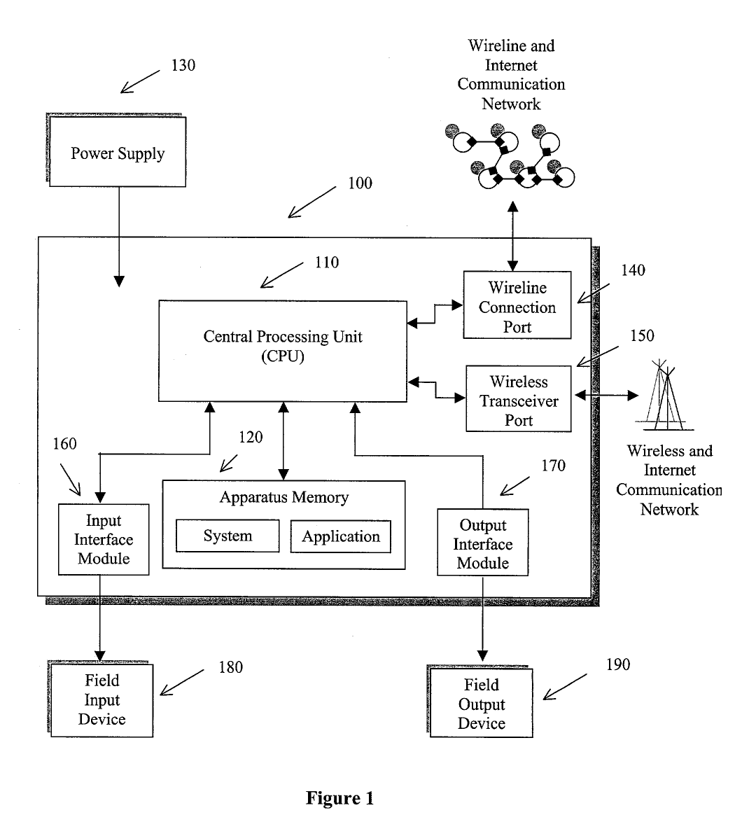

FIG. 1 shows the components of System Apparatus of Programmable Logic Controller 100. The main component of System Apparatus of Programmable Logic Controller 100 is Central Processing Unit 110. Central Processing Unit 110 is connected to an Apparatus Memory 120, a Wireline Connection Port 140, a Wireless Transceiver Port 150, a plurality of Input Interface Module 160, and a plurality of Output Interface Module 170. Input Interface Module 160 is connected to a plurality of Field Input Device 180, and Output Interface Module is connected to a plurality of Field Output Device 190. System Apparatus of Programmable Logic Controller 100 is connected by a Power Supply 130. Central Processing Unit 110 receives input from Input Interface Module 160, executes necessary logic or sequencing functions, and determines appropriate output sent to Output Interface Module 170. Many forms of Central Processing Unit 110 can be used in this invention ranging from low end 8 bit to high end 64 bit microprocessor. Apparatus Memory 120 includes system memory and application memory. System memory contains program instruction codes for real-time operation system, runtime language executor, and network configurations. System memory is installed by PLC manufacturer and can not be altered. Application memory contains program instruction codes for logic, sequencing, I/O interface, and data files. Application memory can be changed by the user when needed. Many forms and memory sizes of Apparatus Memory 120 can be used in this invention ranging from ROM (Read-Only Memory), EPROM (Erasable Programmable Read-Only Memory) to Flush RAM (Random-Access Memory). Input Interface Module 160 receives analog signal from Field Input Device 180 and converts it to binary 0 and 1 values so that Central Processing Unit 110 can process it. Output Interface Module 170 performs an opposing operation by taking 0 and 1 binary data from Central Processing Unit 110 and converting it into an analog signal to be sent to Field Output Device 190. Input Interface Device 160 can also receive discrete input from Field Input Device 180 and Output Interface Module 170 can also send out discrete output to Field Output Device 190. In this case, no analog-to-digital (A/D) and digital-to-analog (D/A) conversion are needed. Both Wireline Connection Port 140 and Wireless Transceiver Port 150 are used by Central Processing Unit 110 to make connection to different communication networks outside PLC. Power Supply 130 is an alternating current (ac) to be used to drive PLC operations. Power Supply 130 can convert 120V ac or 240V ac to low voltage direct current (dc) which is more suitable for Central Processing Unit 110, Input Interface Module 160, Output Interface Module 170 to use.

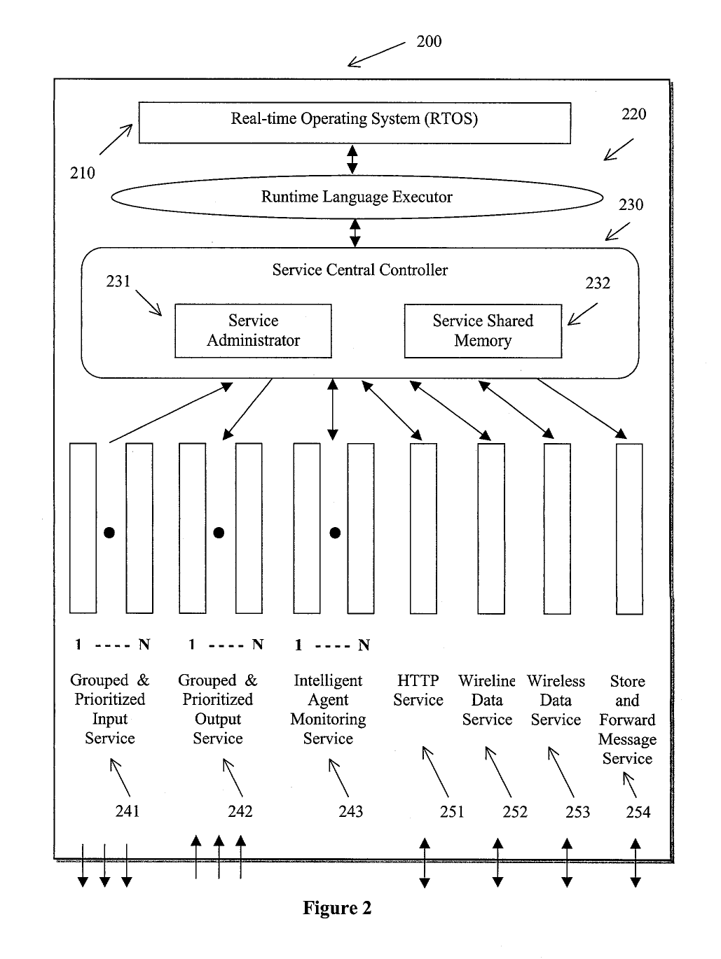

FIG. 2 shows the components of System Software of Embedded Intelligent Web Server 200. System Software of Embedded Intelligent Web Server 200 resides in Central Processing Unit 110 and is comprised of a Real-time Operation System (RTOS) 210, a Runtime Language Executor 220, a Service Central Controller 230. Further, Service Central Controller is comprised of a Service Administrator 231, a Service Shared Memory 232, a plurality of Grouped and Prioritized Input Service 241, a plurality of Grouped and Prioritized Output Service 242, a plurality of Intelligent Agent Monitoring Service 243, a HTTP Service 251, a Wireline Data Service 252, a Wireless Data Service 253, and a Store and Forward Message Service 254. Real-time Operation System 210 controls the operation of Central Processing Unit 110. The operating functions of Real-time Operation System 210 includes system startup, memory configurations, I/O configurations, data file configuration, application execution and system shutdown. Although many kinds of real-time operation system, such as DOS, Unix, and Linux, can be used in this invention, the size of program codes needs to be small and compact so that it will not take too much memory space of Apparatus Memory 120. Runtime Language Executor 220 runs on the top of Real-time Operation System 210. Runtime Language Executor 220 executes program instruction codes of PLC applications. Although Java language from Sun Microsystems is the preferred language for Runtime Language Executor 220 of this invention, other languages, such as C and C++, can also be used. Service Central Controller 230 runs on the top of Runtime Language Executor 220. Service Central Controller 230 administrates and manages both control and system related services for PLC operations. Service Administrator 231 of Service Central Controller 230 registers, installs, activates, deactivates, and uninstalls all services dynamically. Service Administrator 231 also tracks dependencies among services, and sends event notifications when needed. In addition, Service Administrator 231 automatically checks registration of any new services that are deployed at runtime. Service Shared Memory 232 of Service Central Controller 230 holds service registration and activation related data after the service is installed. During PLC operations, temporally data for each service or message are also kept at Service Shared Memory 232. Each entry of data at Service Shared Memory 232 contains enrty's owner, time stamp, access and update authorization, and data sharing permission. All entries of Service Shared Memory 232 will be cleared when the system is shutdown. Grouped and Prioritized Input Service 241 is a control related service. All input signals from Field Input Device 180 are divided into separate groups with different priority settings. Service for each input group is deployed separately and run concurrently under separate system threads. The input signal with the highest priority in a group is scanned first in each scan cycle. Grouped and Prioritized Output Service 242 is a control related service. All output signals from Field Output Device 190 are also divided into separate groups with different priority settings. Service for each output group is also deployed separately and the value of output with a highest priority in a group is changed first. Intelligent Agent Monitoring Service 243 is a control related service. Each Intelligent Agent Monitoring Service 243 consists of a generic rule engine and a set of service rules: Although XML (eXtensible Markup Language) is the preferred script language of this invention for defining the semantic of service rules, other languages, such as KQML (Knowledge Query and Manipulation Language) or plain text can also be used. Each service rule contains multiple condition parts and multiple action parts. The condition portion of service rule derives its data from Service Shared Memory 232, and the action portion of service rules may result in a message written to Service Shared Memory 232 for future dispatching. At runtime, the generic rule engine is used to process these service rules. Both Wireline Data Service 252 and Wireless Data Service 253 are a system related services, and are used to link System Apparatus of Programmable Logic Controller 100 to outside world through wireline or wireless communication network. HTTP Service 251 is a system related service, and contains a thin HTTP Web server for direct Internet access. HTTP Service 251 uses Wireline Data Service 252 and/or Wireless Data Service 253 as underlying network transporter. Store and Forward Message Service 254 is also a system related service. Store and Forward Message Service 254 uses Wireline Data Service 252 and/or Wireless Data Service 253 as communication medium to transmit messages. Store and Forward Message 254 will temporally store messages at Service Shared Memory 232 when direct network access is not available and delivery the message to the intended destination when access is resumed.

Preferred Embodiment—Operation

The operation of System Apparatus of Programmable Logic Controller 100 can be configured into three levels of usage. At lowest level of usage, only Grouped and Prioritized Input Service 241, Grouped and Prioritized Output Service 242, HTTP service 251, and Wireline Data Service 252 are installed and activated. If all input scans and all output scans are classified in the same group with the same priority setting, the control functions are similar to traditional PLC operations. At the middle level of usage, multiple control services of Intelligent Agent Monitoring Service 243 can be added to PLC operations. In addition to traditional logic and sequencing functions, these services allow System Apparatus of Programmable Logic Controller 100 to monitor and control more complex tasks. At the highest level of usage, system services of Wireless Data Service 253, and Store and Forward Message Service 254 can be added to PLC operations. These additional services not only let System Apparatus of Programmable Logic Controller 100 to be accessible wirelessly, but also allow apparatus status, alarm trigging and messaging to be dispatched to different destinations even when communication network traffic is highly congested or direct network access is temporally unavailable. All these three level of usages for System Apparatus of Programmable Logic Controller 100 are possible because the invention uses the service-based application method which allows new service to be registered, installed, and activated at runtime without the interruption of other services.

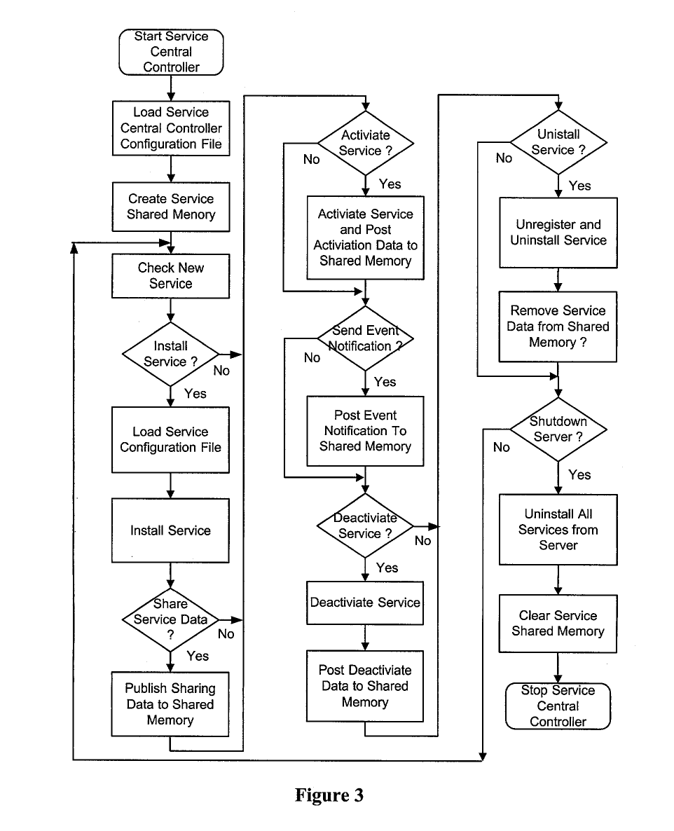

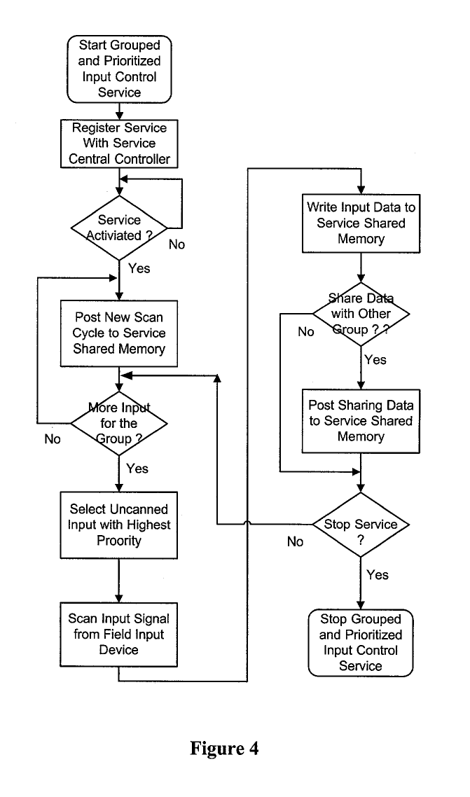

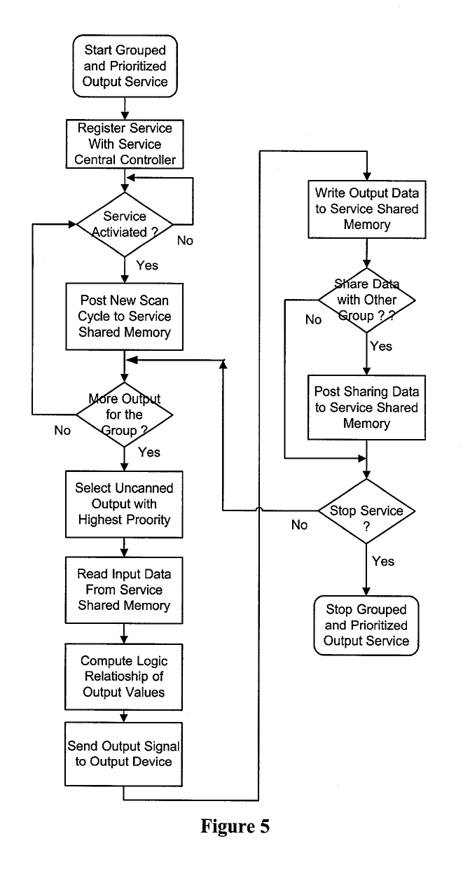

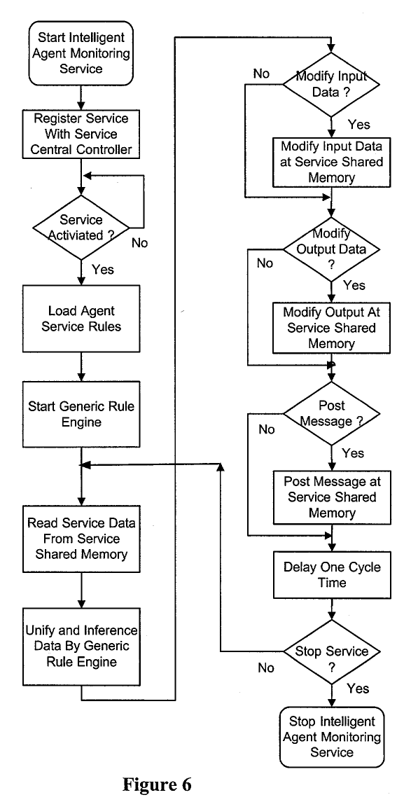

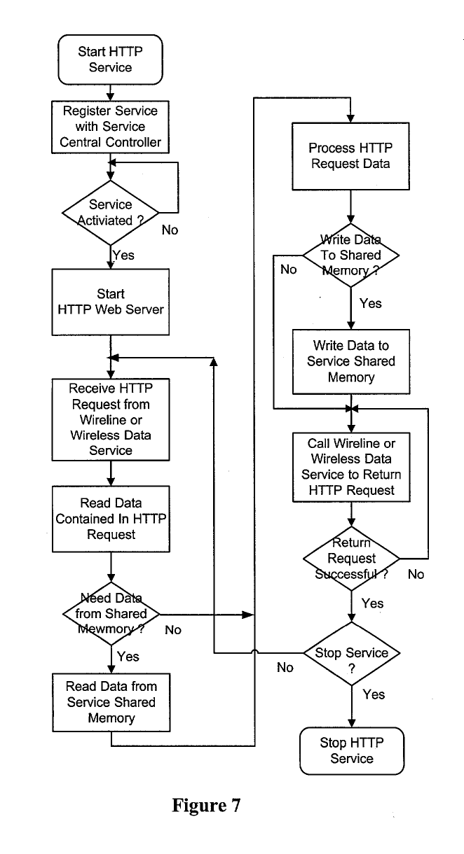

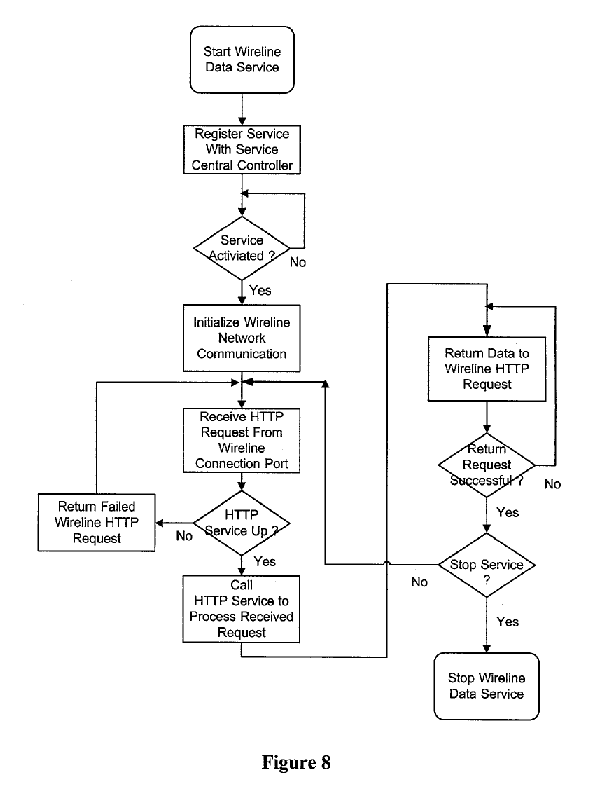

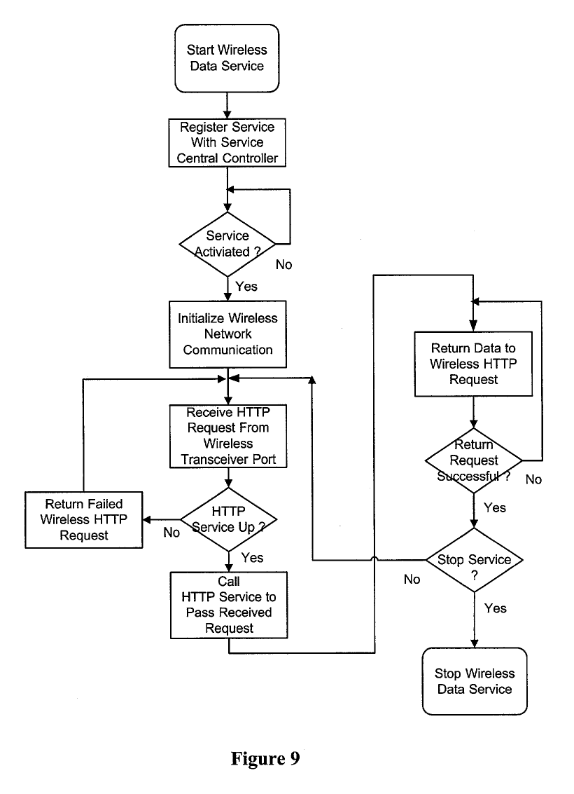

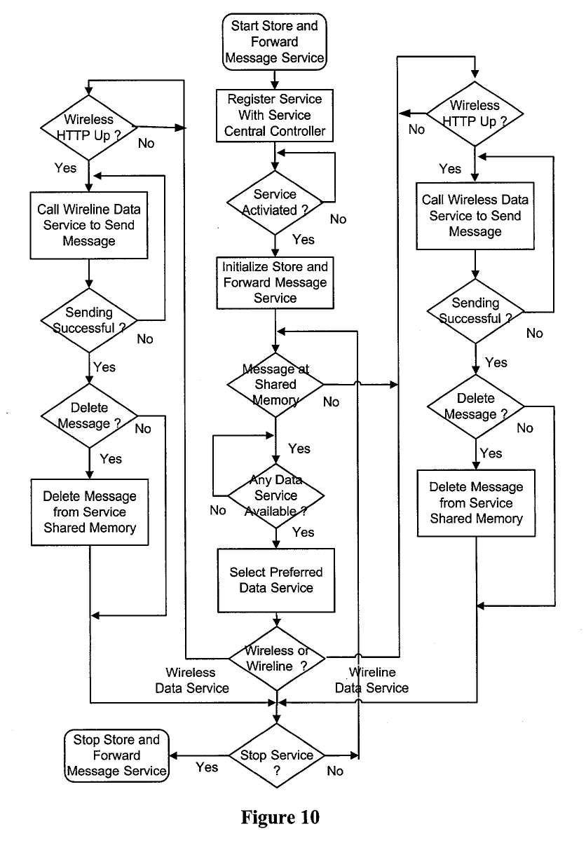

FIG. 3 through FIG. 10 are more detailed flow charts of the operation of System Software of Embedded Intelligent Web Server 200. FIG. 3 illustrates the operations of Service Central Controller 230. FIG. 4 illustrates the operations of Grouped and Prioritized Input Service 241. FIG. 5 illustrates the operations of Grouped and Prioritized Output Service 242. FIG. 6 illustrates the operations of Intelligent Agent Monitoring Service 243. FIG. 7 illustrates the operations of HTTP Service 251. FIG. 8 illustrates the operations of Wireline Data Service 252. FIG. 9 illustrates the operations of Wireless Data Service 253. FIG. 10 illustrates the operations of Store and Forward Message Service 254.

When System Apparatus of Programmable Logic Controller 100 started, Real-time Operation System 210 is first loaded into Central Processing Unit 110 from Apparatus Memory 120. Once loaded, Real-time Operation System 210 proceeds to configure memory segment, I/O module and necessary data file. Runtime Language Executor 220 is then loaded into to system memory by Real-time Operation System 210. Once in the memory, Runtime Language Executor 220 loads Service Central Controller 230 automatically. Service Central Controller 230 first starts to read its configuration file and then performs necessary configuration. After Service Central Controller 230 is up, it registers all services and installs them if needed. Service Central Controller 230 also publishes those services that can be used by other services. After a service is installed, Service Central Controller 230 updates service entry at Service Shared Memory 232. During service operation, Service Central Controller 230 can activate, deactivate, and uninstall a service at system request or by service condition trigging. In addition, Service Controller 230 automatically checks registration of any new services that are deployed at runtime, and installs them if needed. At system shutdown, Service Central Controller 230 uninstalls all services, and clears all entries at Service Shared Memory 232.

Grouped and Prioritized Input Service 241 begins with the loading of its configuration file that includes grouping of inputs and priority settings. At the beginning of Grouped and Prioritized Input Service 241 scan cycle, input service related data are posted to Service Shared Memory 232. Once an input scan cycle starts, Grouped and Prioritized Input Service 241 selects the input with the highest priority to be scanned first. After an input signal has been scanned, Grouped and Prioritized Input Service 241 posts scanned data to Service Shared Memory 232. If the data can be accessed by other service, Grouped and Prioritized Input Service 241 sets proper data sharing permission at Service Shared Memory 232. Grouped and Prioritized Input Service 241 can be deactivated or uninstalled depending on service conditions or at system request. Grouped and Prioritized Output Service 242 operates in a similar way to Grouped and Prioritized Input Service 241. Grouped and Prioritized Output Service 242 begins with the loading of its configuration file that includes grouping of outputs and priority settings. At the beginning of Grouped and Prioritized Output Service 242 scan cycle, output service related data are posted to Service Shared Memory 232. Once an output scan cycle starts, Grouped and Prioritized Output 242 selects the output with the highest priority to be scanned first. Grouped and Prioritized Output Service 242 is then read input data from Service Shared Memory 232. The data could come from service's own group or from other groups. Once all input data available to Grouped and Prioritized Output Service 242 are read, it computes a necessary logic relationship, and determines what action to be taken. If output action is needed, Grouped and Prioritized Output Service 242 sends signals to change the value of Field Output Device 190, and posts the change to Service Shared Memory 232. The change can be used as an input at the next scan cycle. If the data needs to be shared with other service groups, Grouped and Prioritized Output Service 242 sets proper data sharing permission at Service Shared Memory 232. Grouped and Prioritized Output Service 242 can be deactivated or uninstalled depending on service conditions or at system request.

Intelligent Agent Monitoring Service 243 begins with the loading of agent configuration file that includes a set of agent service rules. Intelligent Agent Monitoring Service 243 then starts generic rule engine. Once Intelligent Agent Monitoring Service 243 is up, it reads data from Service Shared Memory 232 posted by other services. These data are used by Intelligent Agent Monitoring Service 243 to unify the condition portion of service rules. The generic rule engine then uses the condition portion of service rules to inference the action portion of service rule, and determines what actions to be taken. The action could be a modification of input data or output data of a particular service group at Service Shared Memory 232. The action could be a modification of data sharing permission at Service Shared Memory 232. The action could also be an alarm or message to be written to Service Shared Memory 232 for future delivery. Permissions to take certain actions by Intelligent Agent Monitoring Service 243 are specified in the agent configuration file. After each inference cycle, Intelligent Agent Monitoring Service 243 will delay for a time period and wait for the next inference cycle to start.

HTTP Service 251 begins with the loading of its configuration file. HTTP Service 251 then starts HTTP Web Server which contains port listeners and request handlers. Once HTTP Service 251 is up, it listens to request from Wireline Connection Port 140 through Wireline Data Service 252 or Wireless Transceiver Port 150 through Wireless Data Service 253. Once the request is received, HTTP Service 251 first validates the authorization and authentication of request specified in the HTTP configuration file. After the request has been validated, HTTP Service 251 reads data contained in the HTTP request, interrogates the data, and determines what actions to be taken. The action could be reading more data from Service Shared Memory 232, or posting data to Service Shared Memory 232. Permissions to take certain actions by HTTP Service 251 are also specified in the HTTP configuration file. HTTP Service 251 then attempts to return HTTP request to its source. If the attempt is not successful, HTTP Service 251 will continue to try as long as Wireline Data Service 252 or Wireless Data Service 253 is available.

Wireline Data Service 252 begins with the loading of its configuration file. Once Wireline Data Service 252 is up, it listens to HTTP request from other sources outside System Apparatus of Programmable Logic Controller 100. The HTTP request is transported by TCP/IP or TCP/UDP protocols through Wireline Connection Port 140. If HTTP Service 251 is not available, the HTTP request is rejected and returned. If HTTP Service 251 is available, Wireline Data Service 252 calls HTTP Service 251 to process the request.

Wireless Data Service 253 also begins with the loading of its configuration file. Wireless Data Service 253 performs similar operations as Wireline Data Service 252, except uses different wireless communication protocols such as RECOMM (RF COM Port), WDP (Wireless Datagram Protocol), WTP (Wireless Transaction Protocol), WSP (Wireless Session Protocol), MIDP (Mobile Information Device Profile), and different wireless communication medium such as wide-area cellular network and short-range Bluetooth RF network. Once Wireless Connection Service 253 is up, it listens to HTTP request from other sources outside System Apparatus of Programmable Logic Controller 100. The HTTP request is transported by above mention wireless protocols through Wireless Transceiver Port 150. If HTTP Service 251 is not available, the HTTP request is rejected and returned. If HTTP Service 251 is available, Wireless Data Service 253 calls HTTP Service 251 to process the request.

Store and Forward Message Service 254 begins with the loading of store and forward message configuration file which contains the delivery information for each destination. This information may include delivery address, preferred data service method, and deposition of message after delivery. Once Store and Forward Message Service 254 is up, it continues to check Service Shared Memory 232 to see if there are any messages needed to be dispatched. If there is a message waiting for delivery, Store and Forward Message Service 254 first checks the availability of all networks. If both Wireline Data Service 252 and Wireless Data Service 253 are available, Store and Forward Message Service 254 will use a preferred data service method specified in its configuration file. If no preference is set, Store and Forward

Message Service 254 will use a default method for message delivery. A message might need to be dispatched to multiple destinations. In this case, Store and Forward Message Service 254 will repeat the same procedure for each destination. Once the message is dispatched to all destinations, Store and Forward Message Service 254 deletes the message from Service Shared Memory 232. Store and Forward Message Service 254 can also be configured to keep the message at Service Shared Memory 232 after it has been delivered for future reference. If the attempt to delivery the message fails, the message will remain at Service Shared Memory 232 until it can be delivered again.

Conclusions, Ramifications, and Scope

Accordingly, it can be seen that the Programmable Logic Controller (PLC) with an Embedded Intelligent Web Server provides an efficient way to develop and deploy service-base applications for PLC operations. Grouped and Prioritized Input and Output Service take advantage of concurrent processing capability of multi-thread system environment and utilize the processing power of CPU to the greatest extent. Intelligent Agent Monitoring Service allows PLC to intelligently handle more complex tasks beyond its basic control functions. HTTP Service, Wireline Data Service and Wireless Data Service expand the accessibility of PLC globally to anywhere and at anytime. In addition, Store and Forward Message Service guarantees PLC message to be delivered even under an unstable network connection situation. And finally, Service Central Controller allows all above services to be plugged in side by side and operated concurrently and cohesively.

Although the description above contains many specificities, these should not be construed as limiting the scope of the invention but as merely providing illustrations of some of the presently preferred embodiments of this invention. Various other embodiments and ramifications are possible within its scope. For example, the service-based application method used for PLCs of this invention can also be used in Internet enabled devices at home for deploying many possible, services. Entertainment service, appliance control service, and message and communication services are a few of such possibilities. Another examples would include more sophisticate intelligent agent services that not only can monitor PLC operations, but also serve as inter-PLC communication control. In this case, one PLC is serving as a master controller which can control a group of subordinating PLCs.

Thus the scope of the invention should be determined by the appended claims and their legal equivalents, rather than by the examples given

What is claimed is:

1. A Programmable Logic Controller (PLC) containing an Embedded Intelligent Web Server that uses a service-based application method to provide control services and system services of said PLC operations.

2. The Programmable Logic Control as recited in claim 1, comprising:
(a) a central processing unit, and means for receiving input from input interface module, executing logic and sequencing functions and sending output to output interface module,
(b) an apparatus memory, and means for storing programming code instructions and data of said control services and said system services,
(c) an wireline connection port, and means for establishing connection with wireline and Internet communication network,
(d) a wireless transceiver port, and means for establishing connection with wireless and Internet communication network,
(e) a plurality of input interface module, and means for receiving discrete input or analog signal from field input device, and converting said analog signal to digital signal to be processed by said central processing unit,
(f) a plurality of output interface module, and means for converting digital signal from said central processing unit to analog signal, and sending discrete output or said analog signal to field output device.

3. The Embedded Intelligent Web Server as recited in claim 1, comprising:
(a) a real-time operating system, and means for executing system operations of system startup, memory configurations, input and output configurations, data file configurations, runtime language applications, and system shutdown of said PLC,
(b) a runtime language executor comprising a programming language, and means for executing application operations of said PLC,
(c) a service central controller, and means for administrating and managing said control services and said system services of said PLC operations.

4. The runtime language executor comprising a programming language as recited in claim 3, wherein said programming language is selectively to use Java programming language.

5. The runtime language executor comprising a programming language as recited in claim 3, wherein said programming language is selectively to use C programming language.

6. The runtime language executor comprising a programming language as recited in claim 3, wherein said programming language is selectively to use C++ programming language.

7. The service central controller as recited in claim 3, comprising:
(a) a service administrator, and means for serving as a central administration of said control services and said system services of said PLC operations,
(b) a service shared memory, and means for providing memory space to store data of said service central controller, said control services, said system services and outgoing messages.

8. The service central controller as recited in claim 3 will administrate and manage of:
(a) a plurality of grouped and prioritized input service,
(b) a plurality of grouped and prioritized output service,
(c) a plurality of intelligent agent monitoring service,
(d) a HTTP (HyperText Transfer Protocol ) service,
(e) a wireline data service,
(f) a wireless data service,
(g) a store and forward message service.

9. The service central controller as recited in claim 3, wherein the said administrating and managing said control services and said system services of said PLC operations, comprising the steps of:
(a) loading configuration file of said service central controller,
(b) creating said service shared memory,
(c) checking registration of new services,
(d) checking status of said control services and said system services,
(e) loading service configuration file of said control services and said system services,
(f) installing said control services and said system services,
(g) publishing data sharing option to said service shared memory of said control services and said system services,
(h) activating said control services and said system services,
(i) updating data entry at said service shared memory of said control services and said system services,
(j) writing event notification to said service shared memory of said control services and said system services,
(k) repeating step (c) through (i) while there are more said control services or said system services to be activated,
(l) deactivating said control services or said system services at request of said service central controller,
(m) posting deactivated data of said control services or system services at said service shared memory,
(n) uninstalling said control services or said system services at request of said service central controller,
(o) removing service data of said control services or said system service from said service shared memory,
(p) uninstalling all services, and clearing said service shared memory at shutdown request of said service central controller.

10. The service as recited in claim 8, wherein said grouped and prioritized input service of (a), comprising the steps of:
(a) registering said grouped and prioritized input service with said service central controller,
(b) checking activation status of said grouped and prioritized input service,
(c) posting new input scan cycle of input group of said grouped and prioritized input service,
(d) checking next input scan of said input group,
(e) selecting input with highest priority of said input group,
(f) scanning field input signal from said field input device of said input,
(g) writing input data to said service shared memory,
(h) posting sharing information of said input data to said service shared memory,
(i) repeating step (d) through (h) while there are input to be scanned of said input group,
(j) repeating step (c) through (h) while said grouped and prioritized input service is activated,
(k) stopping said grouped and prioritized input service at request of said service central controller.

11. The service as recited in claim 8, wherein the said grouped and prioritized output service of (b), comprising the steps of:
(a) registering said grouped and prioritized output service with said service central controller,
(b) checking activation status of said grouped and prioritized output service,
(c) posting new output scan cycle of output group of said grouped and prioritized output service,
(d) checking next output scan of said output group,
(e) selecting output with highest priority of said output group,
(f) reading input data from said service shared memory,
(g) computing logic relationship of output data,
(h) writing said output data to said service shared memory,
(i) posting data sharing information of said output data to said service shared memory,
(j) repeating step (d) through (i) while there are output to be scanned of said output group,
(k) repeating step (c) through (i) while said grouped and prioritized output service is activated,
(l) stopping said grouped and prioritized output service at request of said service central controller.

12. The service as recited in claim 8, wherein the said intelligent agent monitoring service of (c), comprising:
(a) a plurality of service rules comprising a script language, and means for describing execution instructions of said intelligent agent monitoring service,
(b) a generic rule engine, and means for executing said service rules.

13. The service rules comprising a script language as recited in claim 12, wherein said script language is selectively to use a XML (eXtensible Markup Language).

14. The service rules comprising a script language as recited in claim 12, wherein said script language is selectively to use a KQML (Knowledge Query and Manipulation Language).

15. The service rules comprising a script language as recited in claim 12, wherein said script language is selectively to use a plain text.

16. The service as recited in claim 8, wherein the said intelligent agent monitoring service of (c), comprising the steps of:
(a) registering said intelligent agent monitoring service with said service central controller,
(b) checking activation status of said intelligent agent monitoring service,
(c) loading service rules of said intelligent agent monitoring service,
(d) starting said generic rule engine of said intelligent agent monitoring service,
(e) reading service data at said service shared memory,
(f) applying said generic rule engine with said service data,
(g) modifying input data at said service shared memory,
(h) modifying output data at said service shared memory,
(i) posting message data to said service shared memory,
(j) delaying one inference cycle of said generic rule engine,
(k) repeating step (e) through (j) while said intelligent agent monitoring service is activated,
(l) stopping said intelligent agent monitoring service at request of said service central controller.

17. The service as recited in claim 8, wherein the said HTTP service of (d), comprising the steps of:
(a) registering said HTTP service with said service central controller,
(b) checking activation status of said HTTP service,
(c) initializing said HTTP service,
(d) receiving HTTP request from wireline data service or wireless data service,
(e) reading data of said HTTP request,
(f) reading data at said service shared memory,
(g) processing said data of said HTTP request,
(h) writing data of said HTTP request to said service shared memory,
(i) returning said HTTP request to said wireline data service or said wireless data service,
(j) repeating step (d) through (i) while there are said HTTP requests from said wireline data service or said wireless data service, and said HTTP service is activated,
(k) stopping said HTTP service at request of said service central controller.

18. The service as recited in claim 8, wherein the said wireline data service of (e) comprising a wireline communication protocol stack.

19. The comprising a wireline communication protocol stack as cited in claim 18, wherein said protocol stack is selectively to use a TCP/IP (Transmission Control Protocol/Internet Protocol) stack.

20. The comprising a wireline communication protocol stack as cited in claim 18, wherein said protocol stack is selectively to use a TCP/UDP (Transmission Control Protocol/User Datagram Protocol) stack.

21. The service as recited in claim 8, wherein the said wireline data service of (e), comprising the steps of:
(a) registering said wireline data service with said service central controller,
(b) checking activation status of said wireline data service,
(c) initializing said wireline data service,
(d) receiving HTTP request from said wireline connection port,
(e) checking said HTTP service,
(f) returning said HTTP request to said wireline connection port when said HTTP service is not available,
(g) calling said HTTP service to process said HTTP request when said HTTP service is available,
(h) returning said HTTP request to said wireline connection port,
(i) repeating step (d) through (h) while there are said HTTP requests from said wireline connection port, and said wireline data service is activated,
(j) stopping said wireline data service at request of said service central controller.

22. The service as recited in claim 8, wherein the said wireless data service of (f) comprising a wireless communication protocol stack.

23. The comprising a wireless communication protocol stack as cited in claim 22, wherein said protocol stack is selectively to use a WDP/WTP (Wireless Datagram Protocol/Wireless Transaction Protocol) protocol stack for WAP (Wireless Application Protocol) wireless communication.

24. The comprising a wireless communication protocol stack as cited in claim 22, wherein said protocol stack is selectively to use a WDP/WSP (Wireless Datagram Protocol/Wireless Session Protocol) protocol stack for WAP wireless communication.

25. The comprising a wireless communication protocol stack as cited in claim 22, wherein said protocol stack is selectively to use a MIDP/CLDC (Mobile Information Device Profile/Connected Limited Device Configuration) protocol stack for mobile device wireless communication.

26. The comprising a wireless communication protocol stack as cited in claim 22, wherein said protocol stack is selectively to use a RFCOM (RF COM Port) protocol stack for Bluetooth wireless communication.

27. The comprising a wireless communication protocol stack as cited in claim 22, wherein said protocol stack is selectively to use a SDP (Service Discovery Protocol) protocol stack for Bluetooth wireless communication.

28. The service as recited in claim 8, wherein the said wireless data service of (f), comprising the steps of:
(a) registering said wireless data service with said service central controller,
(b) checking service activation status of said wireless data service,
(c) initializing said wireless data service,
(d) receiving HTTP request from wireless transceiver port,
(e) checking said HTTP service,
(f) returning said HTTP request to said wireless transceiver port when said HTTP service is not available,
(g) calling said HTTP service to process said HTTP request when said HTTP service is available,
(h) returning said HTTP request to said wireless transceiver port,
(i) repeating step (d) through (h) while there are said HTTP requests from said wireless transceiver port, and said wireless data service is activated,
(j) stopping said wireless data service at request of said service central controller.

29. The service as recited in claim 8, wherein the said store forward message service of (g), comprising the steps of:
(a) registering said store and forward message service with said service central controller,
(b) checking activation status of said store and forward message service,
(c) initializing said store and forward message service,
(d) checking next message at said service shared memory,
(e) reading message from said service shared memory,
(f) checking connection at said wireline data service,
(g) checking connection at said wireless data service,
(h) selecting preferred network transmission method,
(i) sending said message through said wireline data service or said wireless data service,
(j) deleting said message from said service shared memory,
(k) repeating step (d) through (j) while there are said messages at said service shared memory, and said store and forward message service is activated,
(l) stopping said store and forward message service at request of said service central controller.
